(19) United States
(12) Patent Application Publication
(10) Pub. No.: US 2023/0032925 A1
(43) Pub. Date: Feb. 2, 2023

(54) IMPROVED ARCHITECTURE FOR COUPLING DIGITAL PIXEL SENSORS AND COMPUTING COMPONENTS

(71) Applicant: META PLATFORMS TECHNOLOGIES, LLC, Menlo Park, CA (US)

(72) Inventors: Ziyun Li, Bellevue, WA (US); Barbara De Salvo, Belmont, CA (US); Xinqiao Liu, Medina, WA (US); Lyle David Bainbridge, San Francisco, CA (US); Andrew Samuel Berkovich, Sammamish, WA (US); Syed Shakib Sarwar, Bellevue, WA (US); Song Chen, Redmond, WA (US); Tsung-Hsun Tsai, Redmond, WA (US)

(21) Appl. No.: 17/729,951

(22) Filed: Apr. 26, 2022

Related U.S. Application Data
(60) Provisional application No. 63/227,214, filed on Jul. 29, 2021.

(51) Int. Cl. H04N 5/232; G06V 10/147; G06V 10/94; G06V 10/10; G06T 7/20; G06V 10/70

(52) U.S. Cl. CPC H04N 5/23229; G06V 10/147; G06V 10/955; G06V 10/16; G06T 7/20; G06V 10/70; G06T 2207/20081; G06T 2207/20084

(57) ABSTRACT

The disclosed system may include a first layer that includes multiple digital pixel sensors configured to detect light. The system may also include a second layer that includes various image processing components configured to process the light detected by the digital pixel sensors. Still further, the system may include a third layer that includes machine learning (ML) hardware processing components. The image processing components of the second layer may be communicatively connected to the ML hardware processing components of the third layer via multiple micro through-silicon vias (uTSVs). Various other methods of manufacturing, apparatuses, and computer-readable media are also disclosed.

### CROSS REFERENCE TO RELATED APPLICATION

This application claims the benefit of U.S. Provisional Application No. 63/227,214, filed 29 Jul. 2021, the disclosures of each of which are incorporated, in their entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates an embodiment of an intelligent image sensing and computing platform.

FIG. 2 illustrates an embodiment of an intelligent image sensing and computing platform in which various layers are expanded to show greater detail.

FIG. 3 illustrates an embodiment of an intelligent image sensing and computing platform in which light data is multiplexed from one layer to another layer.

FIG. 4 illustrates a computing layer of an intelligent image sensing and computing platform.

FIG. 5 is a flow diagram of an exemplary method for manufacturing an intelligent image sensing and computing platform.

FIG. 6 illustrates an embodiment in which multiple cores and smart applications are implemented to processes single images and sequences of images.

FIG. 7 illustrates an embodiment in which an image is divided into different sections, each of which is processed by a machine learning processor core.

FIG. 8 illustrates an embodiment in which a sequence of images is analyzed by different machine learning processor cores.

FIG. 9 is an illustration of exemplary augmented-reality glasses that may be used in connection with embodiments of this disclosure.

FIG. 10 is an illustration of an exemplary virtual-reality headset that may be used in connection with embodiments of this disclosure.

FIG. 11 is an illustration of exemplary haptic devices that may be used in connection with embodiments of this disclosure.

FIG. 12 is an illustration of an exemplary virtual-reality environment according to embodiments of this disclosure.

FIG. 13 is an illustration of an exemplary augmented-reality environment according to embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to digital pixel sensor (DPS) chips that allow for incorporation of machine learning (ML) chips connected via micro through-silicon vias (uTSVs). Traditional on-sensor computing systems such as DPS chipsets typically include three layers: 1) a photodiode layer, 2) a combined analog-to-digital converter (ADC) and memory layer, and 3) a machine learning logic layer that has an ML processor. Within such conventional three-layer systems, image data are transferred from the second layer to the third layer via data transfer interfaces, such as Mobile Industry Processor Interface (MIPI) interfaces. These MIPI interfaces, however, have high area overhead on the second and third layers. Indeed, MIPI interfaces result in large amounts of “keep-out” space on the chips that is virtually unusable. Accordingly, chipset layout and total capacity to hold electrical components is limited in such traditional systems.

Moreover, these conventional systems typically consume high amounts of energy when transferring image data. Because the photodiode layer (layer one) is typically fabricated using older and larger technology nodes, as compared with current computing technologies that allow computer processors to be produced at a much smaller scale on much smaller nodes, these traditional systems consume more power when performing processing operations. Moreover, the large area requirements of MIPI transfer interfaces limit the number of transistors and other electronic components that can be fit onto a given third-layer ML processor.

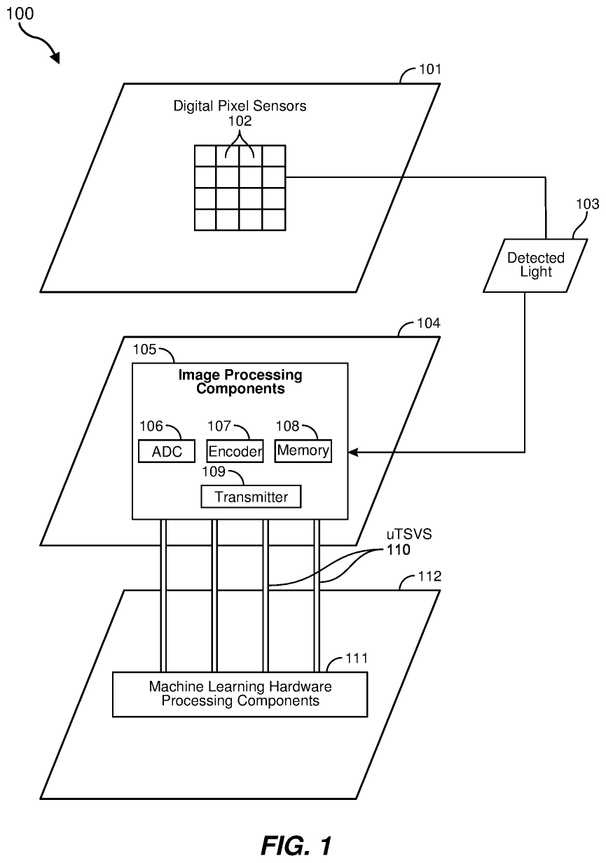

In contrast, the embodiments described herein may implement dense micro through-silicon vias to communicate image data from an image sensing layer to a machine learning processing layer. By using uTSVs, the embodiments described herein may transfer image data from a second layer of a DPS to the third layer with high amounts of parallelism. To provide this parallelism, the systems herein may be configured to divide a pixel array on the first layer (e.g., an image sensing, photodiode layer) into multiple smaller blocks or sections. These systems may then be configured to pack the image data of each section together for transfer through uTSVs to a third layer (e.g., a machine learning processing layer). The ML processing layer may, itself, be divided into multiple cores, where each core on the ML layer is equipped with a dedicated uTSV array to receive image data from the sensing layer and process that data in a parallel and distributed manner. By providing parallelism in this manner, the systems herein may process image data much faster and with less power than traditional systems. Moreover, the high amount of bandwidth provided by uTSVs may allow new types of smart machine learning applications to be processed on the ML processing layer. These concepts will be described further below with regard to FIGS. 1-13.

Features from any of the embodiments described herein may be used in combination with one another in accordance with the general principles described herein. These and other embodiments, features, and advantages will be more fully understood upon reading the following detailed description in conjunction with the accompanying drawings and claims.

FIG. 1 illustrates an embodiment of a system 100 that includes multiple component parts. Each of these component parts may form an intelligent image sensing and computing platform that is more compact, more energy efficient, and provides faster computing power than traditional digital pixel sensor (DPS) imaging systems. The system 100 of FIG. 1 may include a first layer 101 that may be referred to herein as an image sensing layer or photodiode layer. The first layer 101 may include multiple different digital pixel sensors 102. These digital pixel sensors may be charge-coupled devices (CCDs), active-pixel sensors (complementary metal-oxide-semiconductor (CMOS) sensors), or other similar image sensing devices. These digital pixel sensors 102 may be configured to detect incoming light when exposed to light via an open shutter. The first layer 101 may include substantially any number or type of digital pixel sensors 102. Moreover, these digital pixel sensors 102 may be arranged in substantially any shape or type of layout.

The first layer 101 may be connected to a second layer 104 that includes one or more image processing components 105 configured to process the light 103 detected by the digital pixel sensors 102. The image processing components 105 of the second layer 104 may include, but are not limited to, analog-to-digital converters (ADCs 106), encoders 107, memory 108 (e.g., random access memory (RAM) or static RAM (SRAM)), transmitters 109 (or transceivers), and other image processing components. In some embodiments, each digital pixel sensor 102 may have its own corresponding ADC on the second layer 104. These ADCs may be configured to convert the detected light 103 (in an analog value) to a digital value that can be stored in memory 108 and/or transmitted to an external data store (e.g., a cloud data store). The encoder 107 may be configured to encode the digital data associated with each of the digital pixels of the first layer 101. The encoding may include converting the digital pixel values to a specified data format or into a specific data structure. The image processing components 105 of the second layer 104 may be connected to the third layer 112 of the system 100 via one or more micro through-silicon vias 110.

Micro through-silicon vias (uTSVs) 110 may refer to vertical electrical connections that pass directly through silicon (or other substrate) between layers of an integrated circuit. Micro through-silicon vias 110 may be much smaller than traditional through-silicon vias and may have a much smaller footprint on a processing chip. Indeed, each use of a TSV on a processing chip results in an area on that chip that is a “keep-out zone” or “dead zone” on which other electronic components (e.g., transistors, capacitors, diodes, etc.) or traces may not be placed. Traditional TSVs typically result in large dead zones on processing chips, reducing the processing power and efficiency of those chips. Micro TSVs, however, have much smaller dead zones and, as such, many more can be implemented on a chip such as a machine learning processor.

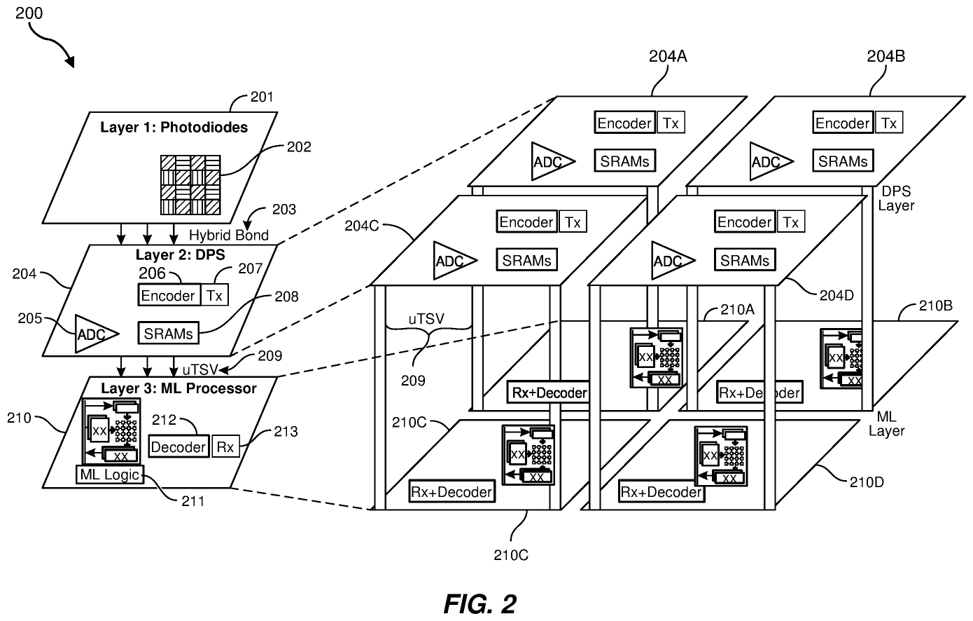

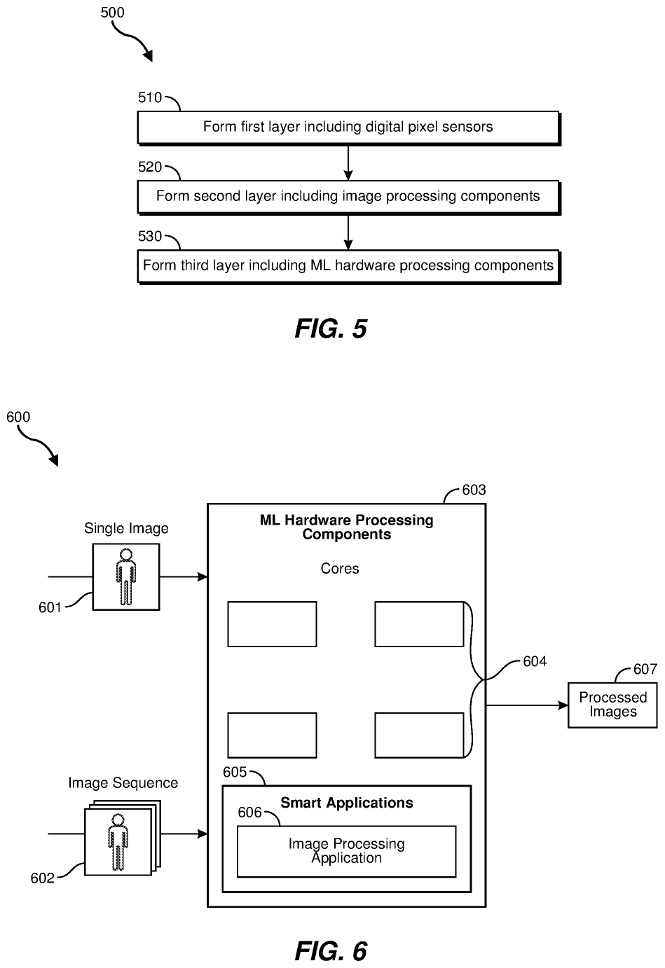

Third layer 112 of the system 100 may include one or more such processing chips in the machine learning (ML) hardware processing components 111. These ML hardware processing components 111 may be communicatively connected to the image processing components 105 of the second layer 104 via one or more uTSVs 110. At least in some embodiments, because uTSVs 110 are used to transfer the digital data produced by the ADCs 106 and/or encoders 107, and because many more uTSVs can be used than in traditional scenarios with TSVs, the digital data may be transferred over in parallel and may be processed in parallel using multiple machine learning cores. In some cases, the digital image data from different quadrants of an image may be sent to different ML chips and/or ML cores within those chips. Each of these ML cores may thus, in parallel, process image data as it comes in and may apply machine learning logic to changes between pixels between subsequent image frames. These embodiments will be explained in greater detail below with regard to FIGS. 2-8 and in conjunction with method 500 of FIG. 5.

FIG. 2 illustrates a digital pixel sensor system 200 that may be similar to or the same as the system 100 of FIG. 1. The digital pixel sensor system 200 may include three (or more) layers including a first layer 201 that has one or more photodiodes 202. The first layer 201 may be bonded to the second layer 204 via a hybrid bond 203 or via some other type of inter-layer bond. The second layer may include ADCs 205, encoders 206, transmitters 207, and memory 208 (e.g., static random-access memory (SRAM)). The second layer 204 may be bonded, at least in some places, via a hybrid bond or other type of bond to the third layer 210. The third layer 210 may include one or more machine learning logic processors 211, one or more decoders 212, and one or more receivers 213. Each of the three layers may be made of silicon or some other semiconductor substrate. In some cases, each of the layers may be made of the same material, while in other cases, at least one of the layers may be made of a different material.

In some cases, the second layer 204 may be divided into multiple segments, including two, three, four, or more different segments. In the embodiment shown in FIG. 2, the second layer 204 of the digital pixel sensor system 200 is divided into four segments, 204A-204D. Each segment 204A-204D may include its own image processing components including its own ADC, its own encoder, its own transmitter, and its own memory (among potentially other components). Similarly, the third layer 210 may also be divided into a corresponding number of segments. Thus, in the embodiment illustrated in FIG. 2, the third layer 210 of system 200 is divided into four different segments, 210A-210D. Each third layer segment 210A-210D may include its own ML logic chip 211, its own decoder 212, and its own receiver 213 (among potentially other components). In some cases, as will be explained below, these ML hardware processing components may be configured to run smart applications that are configured to control the capture of consecutive image frames and execute smart applications (including smart image processing application) to analyze patterns between subsequent images. These smart applications may be capable of handling large amounts of input data, as it is transferred from the photodiodes through the ADCs and to the ML processing chips using the uTSVs 209.

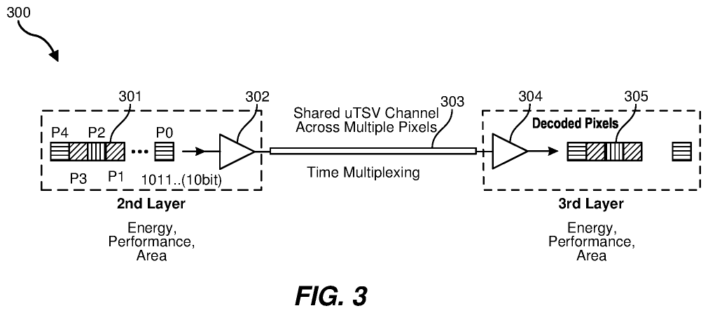

The computing environment 300 of FIG. 3 illustrates an embodiment in which data may be transferred between a second layer and a third layer. Such embodiments may be designed to optimize the parameters of uTSVs, including higher density, smaller size, driver circuit control, available communication protocols, etc. Such optimizations may enable tight three-dimensional (3D) integrated circuit (IC) integration of the ML processor on the third layer of the system. FIG. 3 illustrates a diagram of transferring data from a second layer to a third layer of a digital pixel sensor system (e.g., a multi-layer integrated circuit). Leveraging uTSVs for data transfer may incur area overhead on the second and third layers, as each uTSV will take up some area on the second and third layers of the integrated circuit. The embodiments herein may be configured to determine an optimum number of uTSVs to implement in a given DPS system. In some cases, the optimal number of uTSVs may depend on the processing bandwidth of the machine learning hardware processors on the third layer. Additionally or alternatively, other characteristics may affect the optimal number of uTSVs including image capture frequency, data transmission frequency, encoder output, and other characteristics. Thus, simply adding a large number of uTSVs to the DPS system, and placing the uTSVs as densely as possible between the second and third layers may not be optimal in all situations.

Accordingly, the embodiments herein may be configured to divide the digital pixel array of the first layer into multiple blocks and then pack the image data of each block together for transfer. For instance, a pixel array 301 may be divided into multiple blocks and fed to an encoder 302. The digital data may then be shared across one or more uTSV channels 303 using time multiplexing or some other type of multiplexing or other transmission method that may speed up the transfer. In some cases, the data may be encoded prior to transfer and, at least in some cases, the data may be compressed prior to transfer using various compression algorithms. On the third layer, the data may be unencoded by decoder 304 (and/or uncompressed, if applicable), resulting in decoded pixel data 305. This decoded pixel data may then be used by the ML processing hardware to identify objects, to track objects, or to perform other types of processing on an image or set of images. In some embodiments, while the third layer is decoding or otherwise processing data, the first and/or second layer may process the next batch of input (e.g., the next image frame). In some examples, processing data concurrently in this fashion may be faster and/or expand the effective quantity of available data storage.

In some cases, different numbers of uTSVs may be modeled using a specific number of photodiode inputs and a specific number of ML processor outputs. Using such modeling, the optimal number of uTSVs may be identified such that the area taken up by uTSV junctures on the second and third layers is not so high that it impedes the amount of processing that can be performed by the ML chips, but is large enough to provide bandwidth sufficient to transfer the available pixel data from the digital pixel sensors. Such simulation may also take into account any multiplexing, encoding, compression, etc. to arrive at an optimal block granularity that is specific to each DPS device, according to its photodiode detectors, image processing hardware, and ML processing hardware.

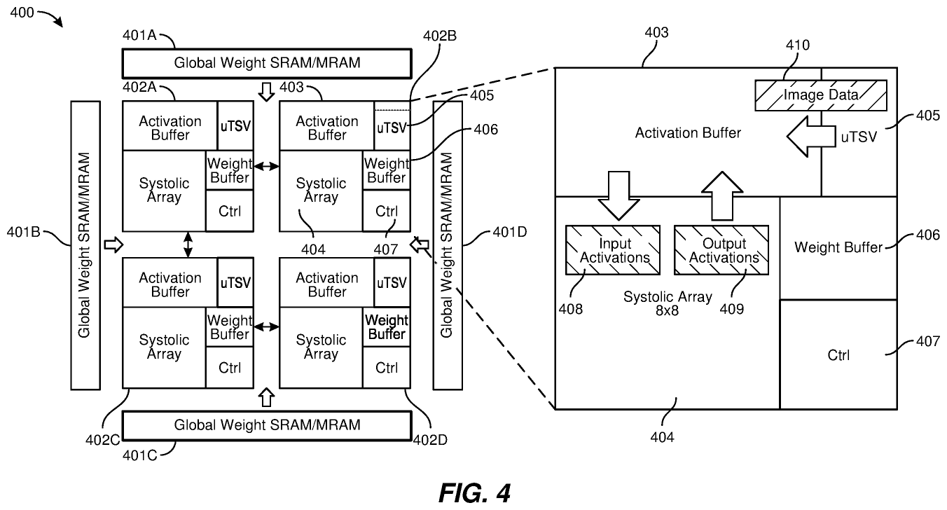

FIG. 4 illustrates an embodiment of a machine learning hardware processor 400 that includes multiple cores 402A-402D. Although four cores are shown, substantially any number of ML processor cores may be included in the ML hardware processor 400. The ML hardware processor may be the same as or different than ML hardware processing components 111 of FIG. 1 or 211 of FIG. 2. In the embodiment shown in FIG. 4, the ML hardware processor 400 includes four global memories 401A-401D that, in some cases, may be used by specific ML cores and, in other cases, may be used by any of the ML cores 402A-402D. Each core may include multiple component parts, as shown in the expanded image of ML core 402B. As illustrated, the expanded version of ML core 402B may include an activation buffer 403 that buffers incoming image data 410 from the uTSV 405. The systolic array 404 may facilitate input activations 408 and output activations 409 as part of smart applications that process the incoming image data 410. These activations may interact with the image data 410 stored in the activation buffer 403. In some cases, the weight buffer 406 may function as a secondary buffer to the activation buffer, while the controller 407 may control the capture of images. Such control may include specifying image sensor exposure time, image capture frequency, amount and type of data stored, etc. Thus, each of the components of the ML hardware processor 400 may work together to perform local processing on image data, including running machine learning applications that may be used to perform artificial reality or virtual reality functions including location tracking, hand or eye tracking, facial recognition, or other similar functions.

In some embodiments, each ML core 402A-402D may be equipped with a dedicated uTSV array to receive data from the sensing layer (e.g., layer one). In some case, each ML core 402A-402D may include multiple uTSV for data transfer. The image data 410 may be transferred from the second layer to the third layer in a parallel and distributed manner using the dedicated uTSV array (e.g., using uTSVs 405). As shown in FIG. 4, the ML hardware processor 400 on the third layer may be split into multiple smaller processing arrays to consume the uTSV data with a processing bandwidth that is much higher than that available in conventional systems. Moreover, splitting the ML hardware processor 400 into multiple smaller processing arrays or processing cores may also allow the ML processor to exploit the spatial relationship of the incoming image data to use less power, provide better performance, and use less area on the chip. This combination of low power, high performance, and low chip area use may enable new types of ML applications to be processed using the ML hardware processor 400. At least some of these ML applications are described below with regard to method 500 of FIG. 5 and FIGS. 6-8

FIG. 5 illustrates a flow diagram of an exemplary computer-implemented method 500 for manufacturing or producing a digital pixel sensor. The steps shown in FIG. 5 may be performed by any suitable computer-executable code and/or computing system. In one example, each of the steps shown in FIG. 5 may represent an algorithm whose structure includes and/or is represented by multiple sub-steps, examples of which will be provided in greater detail below.

At step 510 of method 500, the method may include forming a first layer that includes multiple digital pixel sensors configured to detect light. These digital pixel sensors may be CCD's, CMOS sensors, or other types of image sensing hardware. The digital pixel sensors may sense light wavelengths and intensities, and may pass that light data to image processing components on a second layer. At step 520, the manufacturing method may include forming a second layer adhered to the first layer, where the second layer includes one or more image processing components configured to process the light detected by the digital pixel sensors. The image processing components may include ADCs, encoders, transmitters, memory, or other electronic components. These components may be configured to process the incoming light data from the digital pixel sensors and prepare it (e.g., format or encode the light data) for processing by a machine learning processor.

Step 530 of method 500 may include forming a third layer adhered to the second layer that includes one or more machine learning (ML) hardware processing components. The image processing components of the second layer may be communicatively connected to the ML hardware processing components of the third layer via one or more uTSVs. In some cases, as shown in FIG. 4, an ML hardware processor may be divided into different parts, each of which may have one or more dedicated uTSVs to pass the encoded data. In some cases, the data for a given image is passed together as a group or block of data. In such cases, for example, the image processing components of the second layer may be configured to concatenate or combine multiple image bits into a combined group of image data bits. This combined group of image data bits may be transferred as a group to the ML hardware processing components of the third layer through the uTSVs (as generally shown in FIG. 3). In some embodiments, the combined group of image data bits may be multiplexed and may be transferred as a group to the ML hardware processing components using, for example, time-based multiplexing. The group of image data bits may be transferred to a single local memory buffer or to multiple local memory buffers on the ML hardware processor. In some cases, image data stored in these local memory buffers may be processed using a systolic array (e.g., 404 of FIG. 4) whose parameters are prestored in the local memory buffer. The systolic array may then use the image data in ML applications or ML data models.

The machine learning models described herein may be or may implement substantially any type of machine learning to train a model. At least in some cases, the machine learning module may be an inferential model. As used herein, the term “inferential model” may refer to pure statistical models, pure machine learning models, or any combination of statistical and machine learning models. Such inferential models may include neural networks such as recurrent neural networks. In some embodiments, the recurrent neural network may be a long short-term memory (LSTM) neural network. Such recurrent neural networks are not limited to LSTM neural networks, and may have any other suitable architecture. For example, in some embodiments, the neural network may be a fully recurrent neural network, a gated recurrent neural network, a recursive neural network, a Hopfield neural network, an associative memory neural network, an Elman neural network, a Jordan neural network, an echo state neural network, a second order recurrent neural network, and/or any other suitable type of recurrent neural network. In other embodiments, neural networks that are not recurrent neural networks may be used. For example, deep neural networks, convolutional neural networks, and/or feedforward neural networks, may be used. In some implementations, the inferential model may be an unsupervised machine learning model, e.g., where previous data (on which the inferential model was previously trained) is not required. In other cases, the ML models may implement feedback loops to learn and improve over time.

As shown in computing environment 600 of FIG. 6, the ML hardware processing components 603 (e.g., ML processing cores 604 of an ML hardware processor) may be configured to perform local processing on a specified portion of an image captured by digital pixel sensors (e.g., on layer one). The ML hardware processing components 603 may include one or more ML processing chips, each of which may include one or more ML processing cores 604. These ML processing cores 604 may receive single images 601 or sequences of images 602 from the digital pixel sensors (e.g., 102 of FIG. 1). The ML hardware processing components 603 may be configured to run smart applications 605, one or more of which may be image processing applications 606. These applications may access the single images 601 or sequences of images 602 and apply some type of ML processing to provide, as an output, one or more processed images 607. In some cases, the ML processing cores 604 may share information to perform centralized processing that stitches together the image(s) captured by the digital pixel sensors.

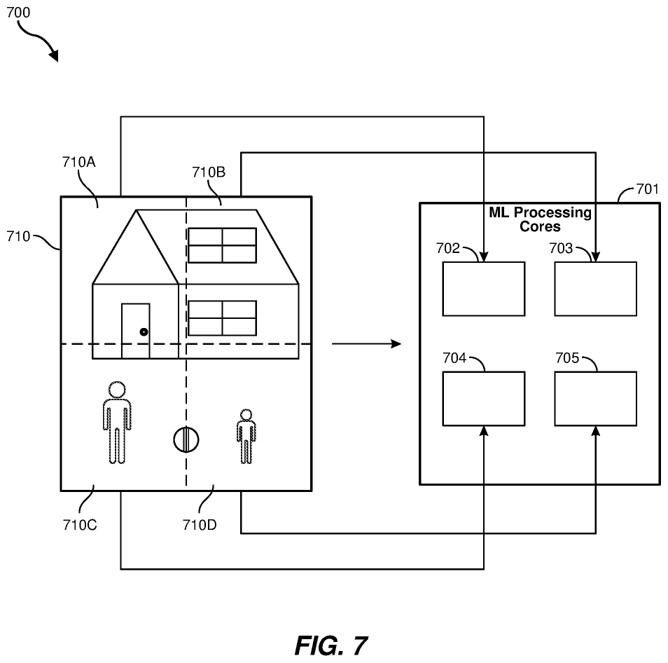

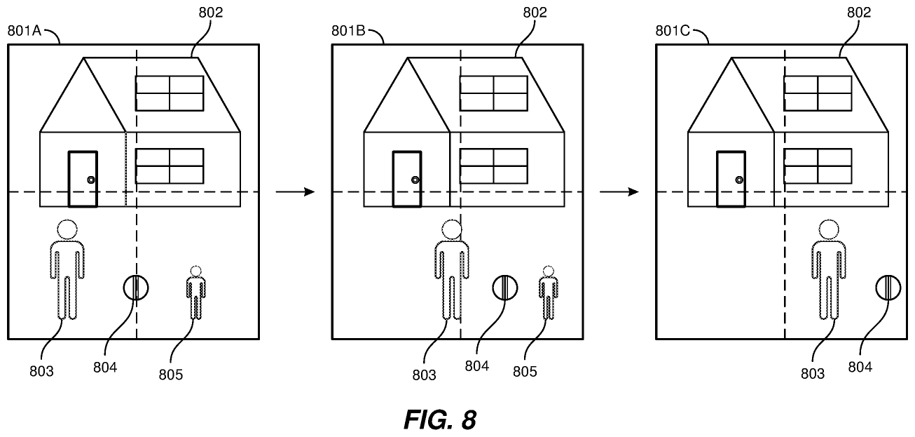

In some cases, for example, as shown in embodiment 700 of FIG. 7, an image 710 may be divided into different sections. In this example, the image 701 has been divided into four different sections (710A-710D), although substantially any number of sections may be used. The layer two (e.g., 104) image processing components 105 may be configured to divide the image into sections, or the ML image processing applications 606 of the ML hardware processing components 603 on layer three may perform the division of the image into different sections. In FIG. 7, an ML processor 701 has four ML processing cores (e.g., 702-705) and, in this example, each ML processing core receives a corresponding section of the image 710. As such, each ML processing core 702-705 may receive a corresponding portion of an image (or sequence of images). The image processing application 606 may then stitch together the different sections of the image if desired. Alternatively, each ML processing core may perform its own analysis without combining the image sections back together.

The ML processor analysis may include a wide variety of tasks, including recognizing objects within images, tracking objects across images, facial recognition, and other tasks. Each ML processing core 702-705 may perform its own individual analysis, or may work in conjunction with one, two, three, or more other ML processing cores to determine, for instance, whether an object has moved between two subsequent image frames. In FIG. 7, for example, ML processing core 704 may receive image section 710C and may identify a person, a portion of a ball, and a portion of a house. ML processing core 705 may recognize a portion of a ball, a different person, and a portion of a house. ML processing cores 702 and 703 may similarly identify portions of a house in their corresponding image sections 710A and 710B. Each ML processing core may be configured to learn from previous images, and may improve its ability to recognize objects, recognize faces, track objects, etc. Each ML core may implement feedback loops to continually improve at each task performed by a smart application 605.

In FIG. 8, three subsequent images 801A, 801B, and 801C may each be divided into four sections. In a manner similar to that shown in FIG. 7, each section may be sent to and analyzed by an ML processing core. In FIG. 8, the ML processing cores may each separately identify objects and track the movement of those objects. For example, ML processing cores 702 and 703 of FIG. 7 may identify portions of a house 802. This house 802 does not move between image frames. However, ML processing cores 704 and 705 may identify persons 803 and 805 and a ball 804. These ML processing cores may be configured to track the recognized people and ball across multiple subsequent images. Thus, as the persons 803 and 805 move between images 801A-801C, the ML processing cores 704 and 705 may recognize that movement and may track these persons, as well as the ball 804, across the different images.

In some cases, the ML processing cores may be configured to track the recognized objects across the subsequent images 801A-801C without neighboring pixel data from other ML processing cores. Thus, for instance, ML processing core 704 may individually recognize and track objects 803 and 804, while ML processing core 705 may individually recognize and track objects 804 and 805 without accessing pixel data from other image sections or from other ML processing cores. In this example, because no changes occur in block 801A & 802, the processing on these image blocks may be skipped, and the corresponding processing cores may be powered down to save energy. Accordingly, each ML processing core may operate individually, and may track the movement of recognized objects until those objects are no longer present in the image. This individual processing may be fed by individual data feeds through dedicated uTSVs at each ML processing core. Each dedicated uTSV may handle the image data for one or more sections of an image. By dividing up an image and then processing each section in parallel on different ML processing cores, the embodiments herein may process images much faster than traditional systems. Moreover, using global memory (e.g., 401A-401D of FIG. 4), ML processing cores may access image data for other image sections, and may, at least in some cases, operate with other ML processing cores to perform a function, including tracking an image across frames. Thus, in the example of FIG. 8, ML processing cores 704 and 705 may work together to track objects 803-805, since those sections of the images are where the movement is occurring. If other objects were moving in other sections, those ML processing cores could, in the same manner, work together to perform a given function.

This framework may be implemented for many different functions, including facial recognition, location tracking, or other functions. Moreover, it will be understood that images may be divided into many different sections in different scenarios. For instance, if an ML processor had eight processing cores, images may be divided into eight sections and correspondingly transmitted through eight uTSVs to the eight ML cores, respectively. Still further, some ML cores may have higher processing capacity and may have two, three, or more dedicated uTSVs for data transfer, while other systems may implement a 1:1 ration between uTSVs and ML processing cores. The embodiments described herein may determine the optimal number of uTSVs for each system, to where the uTSV for each ML processing core provides a high enough bandwidth to keep the core fully utilized, but to where there aren't so many uTSVs that processor core space on the ML hardware processor is taken up by uTSV attachment points. This balance includes tradeoffs that may be assessed and determined for each specific digital pixel sensor system.

Accordingly, a system may be provided that may increase digital pixel sensor output by implementing uTSVs for different ML processing cores. These uTSVs may provide a sufficiently high bandwidth stream to keep the ML processing cores fully utilized, while taking up a minimal amount of space on the second and third layers of the digital pixel sensor system. Moreover, the ML processing cores may be implemented alone or in conjunction with each other to execute smart applications including machine learning-based image processing applications.

### Example Embodiments

Example 1: A system may include a first layer that includes a plurality of digital pixel sensors configured to detect light, a second layer that includes one or more image processing components configured to process the light detected by the digital pixel sensors, and a third layer that includes one or more machine learning (ML) hardware processing components, where the image processing components of the second layer are communicatively connected to the ML hardware processing components of the third layer via one or more micro through-silicon vias (uTSVs).

Example 2: The system of Example 1, wherein the image processing components of the second layer comprise at least one of an analog-to-digital converter (ADC), an encoder, a memory, or a transmitter.

Example 3:The system of any of Examples 1 and 2, wherein the ML hardware processing components control capture of consecutive image frames.

Example 4: The system of any of Examples 1-3, wherein the ML hardware processing components are configured to execute one or more smart applications.

Example 5: The system of any of Examples 1-4, wherein at least one of the one or more smart applications comprises a smart image processing application.

Example 6: The system of any of Examples 1-5, wherein the ML hardware processing components include a plurality of processing cores.

Example 7: The system of any of Examples 1-6, wherein one or more of the processing cores are configured to perform local processing on a specified portion of an image captured by the plurality of digital pixel sensors.

Example 8: The system of any of Examples 1-7, wherein the ML processing cores share information to perform centralized processing that stitches the image captured by the plurality of digital pixel sensors together.

Example 9: The system of any of Examples 1-8, wherein one or more of the processing cores is configured to recognize one or more objects within a specified region of an image.

Example 10: The system of any of Examples 1-9, wherein one or more of the processing cores is configured to track the one or more recognized objects across a plurality of subsequent images.

Example 11: The system of any of Examples 1-10, wherein the one or more recognized objects are tracked across the plurality of subsequent images without neighboring pixel data from other ML processing cores.

Example 12: The system of any of Examples 1-11, wherein the one or more recognized objects are processed by the same ML processing core until the objects are no longer present in the image.

Example 13: The system of any of Examples 1-12, wherein the one or more recognized objects are processed by a plurality of ML processing cores upon determining that the objects have moved between images.

Example 14: An electronic device may include a first layer that includes a plurality of digital pixel sensors configured to detect light, a second layer that includes one or more image processing components configured to process the light detected by the digital pixel sensors, and a third layer that includes one or more machine learning (ML) hardware processing components, wherein the image processing components of the second layer are communicatively connected to the ML hardware processing components of the third layer via one or more uTSVs.

Example 15: The electronic device of Example 14, wherein the image processing components of the second layer are configured to combine a plurality of image bits into a combined group of image data bits.

Example 16: The electronic device of any of Examples 14 and 15, wherein the combined group of image data bits is transferred as a group to the ML hardware processing components of the third layer through the uTSVs.

Example 17: The electronic device of any of Examples 14-16, wherein the combined group of image data bits is transferred as a group to the ML hardware processing components using time-based multiplexing.

Example 18: The electronic device of any of Examples 14-17, wherein at least one of the ML hardware processing components comprises a local memory buffer.

Example 19: The electronic device of any of Examples 14-18, wherein image data stored in the local memory buffer is processed using a systolic array whose parameters are prestored in the local memory buffer.

Example 20: A method of manufacture may include forming a first layer that includes a plurality of digital pixel sensors configured to detect light, forming a second layer adhered to the first layer that includes one or more image processing components configured to process the light detected by the digital pixel sensors, and forming a third layer adhered to the second layer that includes one or more machine learning (ML) hardware processing components, wherein the image processing components of the second layer are communicatively connected to the ML hardware processing components of the third layer via one or more uTSVs.

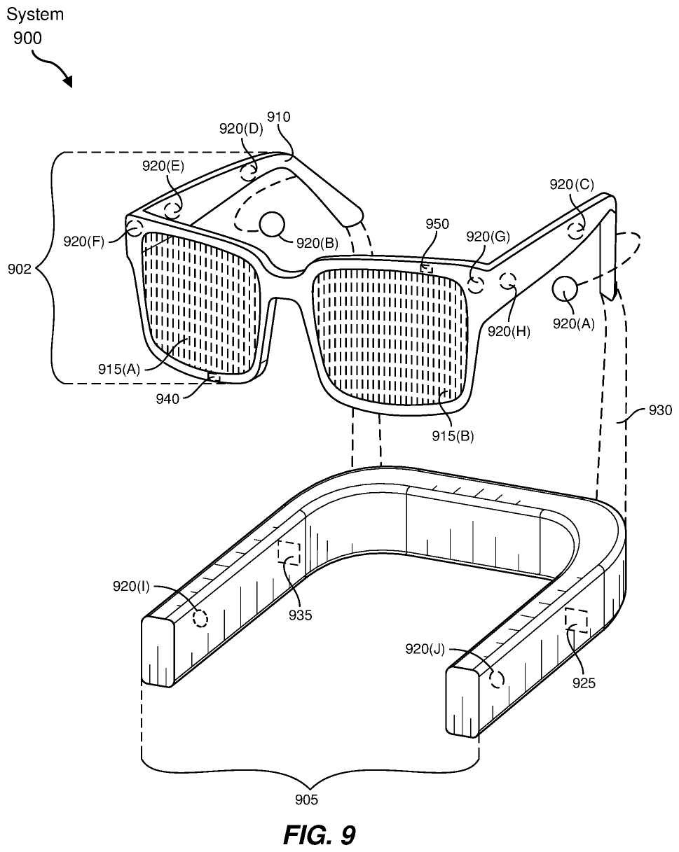

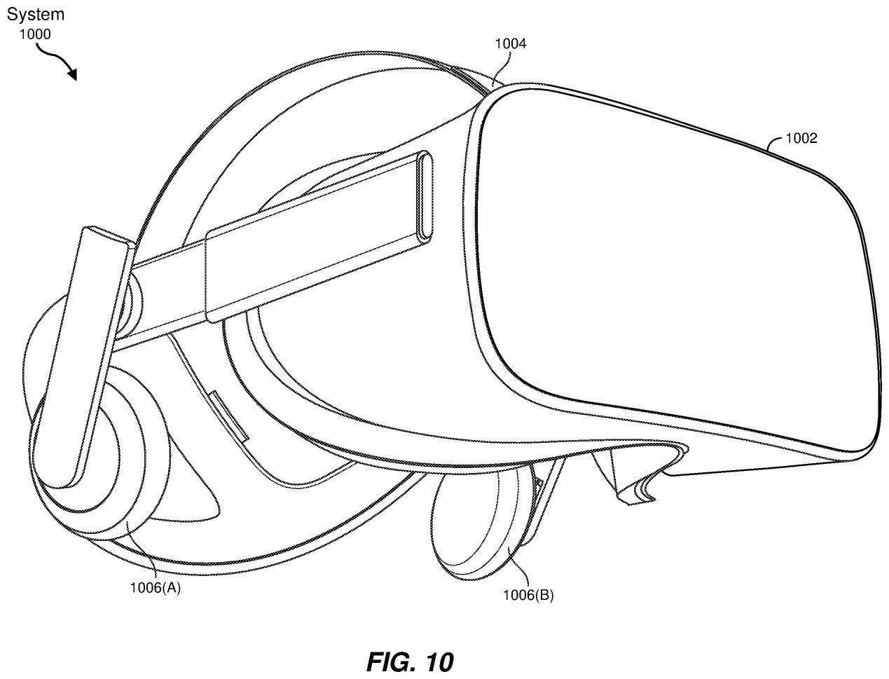

The digital pixel sensor systems described herein may be used in a variety of different computing environments, including artificial reality environments. Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 900 in FIG. 9) or that visually immerses a user in an artificial reality (such as, e.g., virtual-reality system 1000 in FIG. 10). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 9, augmented-reality system 900 may include an eyewear device 902 with a frame 910 configured to hold a left display device 915(A) and a right display device 915(B) in front of a user's eyes. Display devices 915(A) and 915(B) may act together or independently to present an image or series of images to a user. While augmented-reality system 900 includes two displays, embodiments of this disclosure may be implemented in augmented-reality systems with a single NED or more than two NEDs.

In some embodiments, augmented-reality system 900 may include one or more sensors, such as sensor 940. Sensor 940 may generate measurement signals in response to motion of augmented-reality system 900 and may be located on substantially any portion of frame 910. Sensor 940 may represent one or more of a variety of different sensing mechanisms, such as a position sensor, an inertial measurement unit (IMU), a depth camera assembly, a structured light emitter and/or detector, or any combination thereof. In some embodiments, augmented-reality system 900 may or may not include sensor 940 or may include more than one sensor. In embodiments in which sensor 940 includes an IMU, the IMU may generate calibration data based on measurement signals from sensor 940. Examples of sensor 940 may include, without limitation, accelerometers, gyroscopes, magnetometers, other suitable types of sensors that detect motion, sensors used for error correction of the IMU, or some combination thereof.

In some examples, augmented-reality system 900 may also include a microphone array with a plurality of acoustic transducers 920(A)-920(J), referred to collectively as acoustic transducers 920. Acoustic transducers 920 may represent transducers that detect air pressure variations induced by sound waves. Each acoustic transducer 920 may be configured to detect sound and convert the detected sound into an electronic format (e.g., an analog or digital format). The microphone array in FIG. 9 may include, for example, ten acoustic transducers: 920(A) and 920(B), which may be designed to be placed inside a corresponding ear of the user, acoustic transducers 920(C), 920(D), 920(E), 920(F), 920(G), and 920(H), which may be positioned at various locations on frame 910, and/or acoustic transducers 920(I) and 920(J), which may be positioned on a corresponding neckband 905.

In some embodiments, one or more of acoustic transducers 920(A)-(J) may be used as output transducers (e.g., speakers). For example, acoustic transducers 920(A) and/or 920(B) may be earbuds or any other suitable type of headphone or speaker.

The configuration of acoustic transducers 920 of the microphone array may vary. While augmented-reality system 900 is shown in FIG. 9 as having ten acoustic transducers 920, the number of acoustic transducers 920 may be greater or less than ten. In some embodiments, using higher numbers of acoustic transducers 920 may increase the amount of audio information collected and/or the sensitivity and accuracy of the audio information. In contrast, using a lower number of acoustic transducers 920 may decrease the computing power required by an associated controller 950 to process the collected audio information. In addition, the position of each acoustic transducer 920 of the microphone array may vary. For example, the position of an acoustic transducer 920 may include a defined position on the user, a defined coordinate on frame 910, an orientation associated with each acoustic transducer 920, or some combination thereof.

Acoustic transducers 920(A) and 920(B) may be positioned on different parts of the user's ear, such as behind the pinna, behind the tragus, and/or within the auricle or fossa. Or, there may be additional acoustic transducers 920 on or surrounding the ear in addition to acoustic transducers 920 inside the ear canal. Having an acoustic transducer 920 positioned next to an ear canal of a user may enable the microphone array to collect information on how sounds arrive at the ear canal. By positioning at least two of acoustic transducers 920 on either side of a user's head (e.g., as binaural microphones), augmented-reality device 900 may simulate binaural hearing and capture a 3D stereo sound field around about a user's head. In some embodiments, acoustic transducers 920(A) and 920(B) may be connected to augmented-reality system 900 via a wired connection 930, and in other embodiments acoustic transducers 920(A) and 920(B) may be connected to augmented-reality system 900 via a wireless connection (e.g., a Bluetooth connection). In still other embodiments, acoustic transducers 920(A) and 920(B) may not be used at all in conjunction with augmented-reality system 900.

Acoustic transducers 920 on frame 910 may be positioned in a variety of different ways, including along the length of the temples, across the bridge, above or below display devices 915(A) and 915(B), or some combination thereof. Acoustic transducers 920 may also be oriented such that the microphone array is able to detect sounds in a wide range of directions surrounding the user wearing the augmented-reality system 900. In some embodiments, an optimization process may be performed during manufacturing of augmented-reality system 900 to determine relative positioning of each acoustic transducer 920 in the microphone array.

In some examples, augmented-reality system 900 may include or be connected to an external device (e.g., a paired device), such as neckband 905. Neckband 905 generally represents any type or form of paired device. Thus, the following discussion of neckband 905 may also apply to various other paired devices, such as charging cases, smart watches, smart phones, wrist bands, other wearable devices, hand-held controllers, tablet computers, laptop computers, other external compute devices, etc.

As shown, neckband 905 may be coupled to eyewear device 902 via one or more connectors. The connectors may be wired or wireless and may include electrical and/or non-electrical (e.g., structural) components. In some cases, eyewear device 902 and neckband 905 may operate independently without any wired or wireless connection between them. While FIG. 9 illustrates the components of eyewear device 902 and neckband 905 in example locations on eyewear device 902 and neckband 905, the components may be located elsewhere and/or distributed differently on eyewear device 902 and/or neckband 905. In some embodiments, the components of eyewear device 902 and neckband 905 may be located on one or more additional peripheral devices paired with eyewear device 902, neckband 905, or some combination thereof.

Pairing external devices, such as neckband 905, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 900 may be provided by a paired device or shared between a paired device and an eyewear device, thus reducing the weight, heat profile, and form factor of the eyewear device overall while still retaining desired functionality. For example, neckband 905 may allow components that would otherwise be included on an eyewear device to be included in neckband 905 since users may tolerate a heavier weight load on their shoulders than they would tolerate on their heads. Neckband 905 may also have a larger surface area over which to diffuse and disperse heat to the ambient environment. Thus, neckband 905 may allow for greater battery and computation capacity than might otherwise have been possible on a stand-alone eyewear device. Since weight carried in neckband 905 may be less invasive to a user than weight carried in eyewear device 902, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 905 may be communicatively coupled with eyewear device 902 and/or to other devices. These other devices may provide certain functions (e.g., tracking, localizing, depth mapping, processing, storage, etc.) to augmented-reality system 900. In the embodiment of FIG. 9, neckband 905 may include two acoustic transducers (e.g., 920(I) and 920(J)) that are part of the microphone array (or potentially form their own microphone subarray). Neckband 905 may also include a controller 925 and a power source 935.

Acoustic transducers 920(I) and 920(J) of neckband 905 may be configured to detect sound and convert the detected sound into an electronic format (analog or digital). In the embodiment of FIG. 9, acoustic transducers 920(I) and 920(J) may be positioned on neckband 905, thereby increasing the distance between the neckband acoustic transducers 920(I) and 920(J) and other acoustic transducers 920 positioned on eyewear device 902. In some cases, increasing the distance between acoustic transducers 920 of the microphone array may improve the accuracy of beamforming performed via the microphone array. For example, if a sound is detected by acoustic transducers 920(C) and 920(D) and the distance between acoustic transducers 920(C) and 920(D) is greater than, e.g., the distance between acoustic transducers 920(D) and 920(E), the determined source location of the detected sound may be more accurate than if the sound had been detected by acoustic transducers 920(D) and 920(E).

Controller 925 of neckband 905 may process information generated by the sensors on neckband 905 and/or augmented-reality system 900. For example, controller 925 may process information from the microphone array that describes sounds detected by the microphone array. For each detected sound, controller 925 may perform a direction-of-arrival (DOA) estimation to estimate a direction from which the detected sound arrived at the microphone array. As the microphone array detects sounds, controller 925 may populate an audio data set with the information. In embodiments in which augmented-reality system 900 includes an inertial measurement unit, controller 925 may compute all inertial and spatial calculations from the IMU located on eyewear device 902. A connector may convey information between augmented-reality system 900 and neckband 905 and between augmented-reality system 900 and controller 925. The information may be in the form of optical data, electrical data, wireless data, or any other transmittable data form. Moving the processing of information generated by augmented-reality system 900 to neckband 905 may reduce weight and heat in eyewear device 902, making it more comfortable to the user.

Power source 935 in neckband 905 may provide power to eyewear device 902 and/or to neckband 905. Power source 935 may include, without limitation, lithium ion batteries, lithium-polymer batteries, primary lithium batteries, alkaline batteries, or any other form of power storage. In some cases, power source 935 may be a wired power source. Including power source 935 on neckband 905 instead of on eyewear device 902 may help better distribute the weight and heat generated by power source 935.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1000 in FIG. 10, that mostly or completely covers a user's field of view. Virtual-reality system 1000 may include a front rigid body 1002 and a band 1004 shaped to fit around a user's head. Virtual-reality system 1000 may also include output audio transducers 1006(A) and 1006(B). Furthermore, while not shown in FIG. 10, front rigid body 1002 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 900 and/or virtual-reality system 1000 may include one or more liquid crystal displays (LCDs), light emitting diode (LED) displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., conventional concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 900 and/or virtual-reality system 1000 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 900 and/or virtual-reality system 1000 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

As noted, augmented-reality systems 900 and 1000 may be used with a variety of other types of devices to provide a more compelling artificial-reality experience. These devices may be haptic interfaces with transducers that provide haptic feedback and/or that collect haptic information about a user's interaction with an environment. The artificial-reality systems disclosed herein may include various types of haptic interfaces that detect or convey various types of haptic information, including tactile feedback (e.g., feedback that a user detects via nerves in the skin, which may also be referred to as cutaneous feedback) and/or kinesthetic feedback (e.g., feedback that a user detects via receptors located in muscles, joints, and/or tendons).

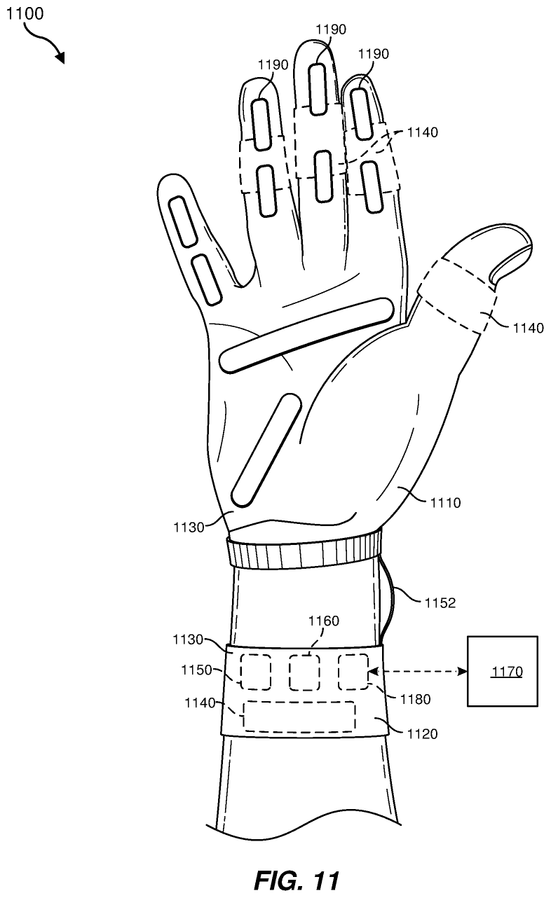

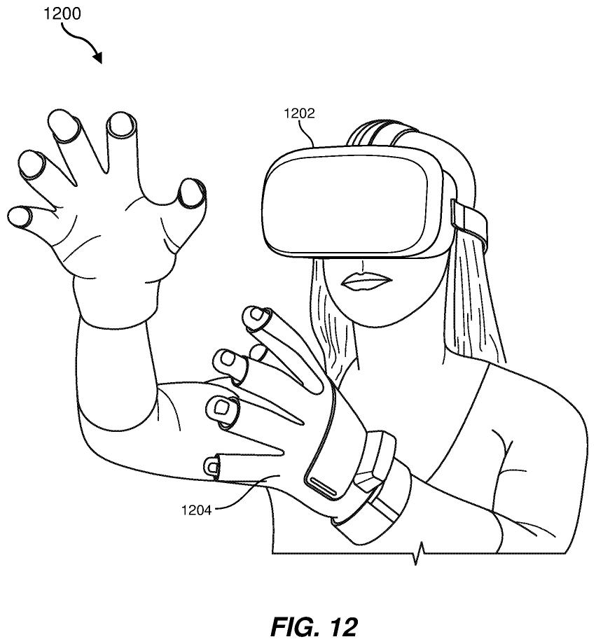

Haptic feedback may be provided by interfaces positioned within a user's environment (e.g., chairs, tables, floors, etc.) and/or interfaces on articles that may be worn or carried by a user (e.g., gloves, wristbands, etc.). As an example, FIG. 11 illustrates a vibrotactile system 1100 in the form of a wearable glove (haptic device 1110) and wristband (haptic device 1120). Haptic device 1110 and haptic device 1120 are shown as examples of wearable devices that include a flexible, wearable textile material 1130 that is shaped and configured for positioning against a user's hand and wrist, respectively. This disclosure also includes vibrotactile systems that may be shaped and configured for positioning against other human body parts, such as a finger, an arm, a head, a torso, a foot, or a leg. By way of example and not limitation, vibrotactile systems according to various embodiments of the present disclosure may also be in the form of a glove, a headband, an armband, a sleeve, a head covering, a sock, a shirt, or pants, among other possibilities. In some examples, the term “textile” may include any flexible, wearable material, including woven fabric, non-woven fabric, leather, cloth, a flexible polymer material, composite materials, etc.

One or more vibrotactile devices 1140 may be positioned at least partially within one or more corresponding pockets formed in textile material 1130 of vibrotactile system 1100. Vibrotactile devices 1140 may be positioned in locations to provide a vibrating sensation (e.g., haptic feedback) to a user of vibrotactile system 1100. For example, vibrotactile devices 1140 may be positioned against the user's finger(s), thumb, or wrist, as shown in FIG. 11. Vibrotactile devices 1140 may, in some examples, be sufficiently flexible to conform to or bend with the user's corresponding body part(s).

A power source 1150 (e.g., a battery) for applying a voltage to the vibrotactile devices 1140 for activation thereof may be electrically coupled to vibrotactile devices 1140, such as via conductive wiring 1152. In some examples, each of vibrotactile devices 1140 may be independently electrically coupled to power source 1150 for individual activation. In some embodiments, a processor 1160 may be operatively coupled to power source 1150 and configured (e.g., programmed) to control activation of vibrotactile devices 1140.

Vibrotactile system 1100 may be implemented in a variety of ways. In some examples, vibrotactile system 1100 may be a standalone system with integral subsystems and components for operation independent of other devices and systems. As another example, vibrotactile system 1100 may be configured for interaction with another device or system 1170. For example, vibrotactile system 1100 may, in some examples, include a communications interface 1180 for receiving and/or sending signals to the other device or system 1170. The other device or system 1170 may be a mobile device, a gaming console, an artificial-reality (e.g., virtual-reality, augmented-reality, mixed-reality) device, a personal computer, a tablet computer, a network device (e.g., a modem, a router, etc.), a handheld controller, etc. Communications interface 1180 may enable communications between vibrotactile system 1100 and the other device or system 1170 via a wireless (e.g., Wi-Fi, Bluetooth, cellular, radio, etc.) link or a wired link. If present, communications interface 1180 may be in communication with processor 1160, such as to provide a signal to processor 1160 to activate or deactivate one or more of the vibrotactile devices 1140.

Vibrotactile system 1100 may optionally include other subsystems and components, such as touch-sensitive pads 1190, pressure sensors, motion sensors, position sensors, lighting elements, and/or user interface elements (e.g., an on/off button, a vibration control element, etc.). During use, vibrotactile devices 1140 may be configured to be activated for a variety of different reasons, such as in response to the user's interaction with user interface elements, a signal from the motion or position sensors, a signal from the touch-sensitive pads 1190, a signal from the pressure sensors, a signal from the other device or system 1170, etc.

Although power source 1150, processor 1160, and communications interface 1180 are illustrated in FIG. 11 as being positioned in haptic device 1120, the present disclosure is not so limited. For example, one or more of power source 1150, processor 1160, or communications interface 1180 may be positioned within haptic device 1110 or within another wearable textile.

Haptic wearables, such as those shown in and described in connection with FIG. 11, may be implemented in a variety of types of artificial-reality systems and environments. FIG. 12 shows an example artificial-reality environment 1200 including one head-mounted virtual-reality display and two haptic devices (i.e., gloves), and in other embodiments any number and/or combination of these components and other components may be included in an artificial-reality system. For example, in some embodiments there may be multiple head-mounted displays each having an associated haptic device, with each head-mounted display and each haptic device communicating with the same console, portable computing device, or other computing system.

Head-mounted display 1202 generally represents any type or form of virtual-reality system, such as virtual-reality system 1000 in FIG. 10. Haptic device 1204 generally represents any type or form of wearable device, worn by a user of an artificial-reality system, that provides haptic feedback to the user to give the user the perception that he or she is physically engaging with a virtual object. In some embodiments, haptic device 1204 may provide haptic feedback by applying vibration, motion, and/or force to the user. For example, haptic device 1204 may limit or augment a user's movement. To give a specific example, haptic device 1204 may limit a user's hand from moving forward so that the user has the perception that his or her hand has come in physical contact with a virtual wall. In this specific example, one or more actuators within the haptic device may achieve the physical-movement restriction by pumping fluid into an inflatable bladder of the haptic device. In some examples, a user may also use haptic device 1204 to send action requests to a console. Examples of action requests include, without limitation, requests to start an application and/or end the application and/or requests to perform a particular action within the application.

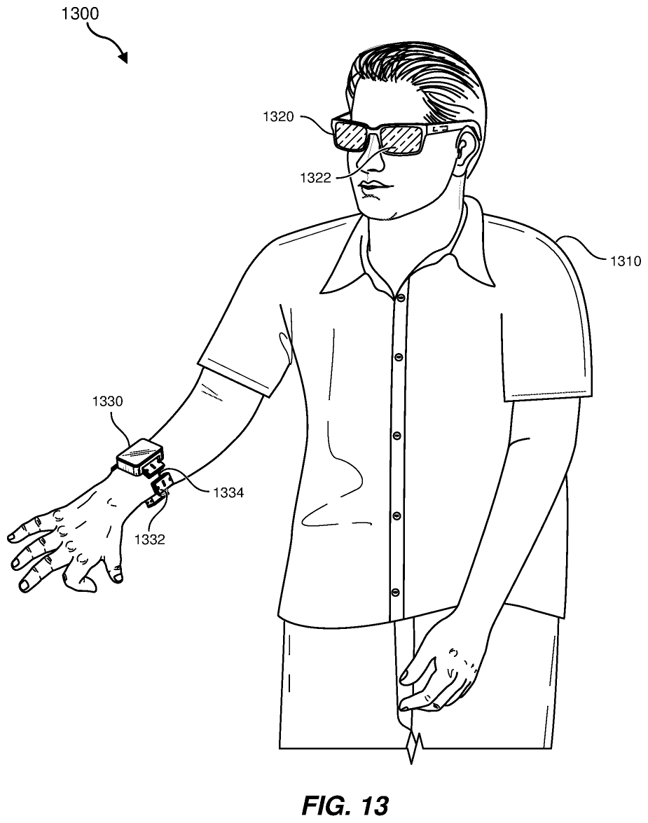

While haptic interfaces may be used with virtual-reality systems, as shown in FIG. 12, haptic interfaces may also be used with augmented-reality systems, as shown in FIG. 13. FIG. 13 is a perspective view of a user 1310 interacting with an augmented-reality system 1300. In this example, user 1310 may wear a pair of augmented-reality glasses 1320 that may have one or more displays 1322 and that are paired with a haptic device 1330. In this example, haptic device 1330 may be a wristband that includes a plurality of band elements 1332 and a tensioning mechanism 1334 that connects band elements 1332 to one another.

One or more of band elements 1332 may include any type or form of actuator suitable for providing haptic feedback. For example, one or more of band elements 1332 may be configured to provide one or more of various types of cutaneous feedback, including vibration, force, traction, texture, and/or temperature. To provide such feedback, band elements 1332 may include one or more of various types of actuators. In one example, each of band elements 1332 may include a vibrotactor (e.g., a vibrotactile actuator) configured to vibrate in unison or independently to provide one or more of various types of haptic sensations to a user. Alternatively, only a single band element or a subset of band elements may include vibrotactors.

Haptic devices 1110, 1120, 1204, and 1330 may include any suitable number and/or type of haptic transducer, sensor, and/or feedback mechanism. For example, haptic devices 1110, 1120, 1204, and 1330 may include one or more mechanical transducers, piezoelectric transducers, and/or fluidic transducers. Haptic devices 1110, 1120, 1204, and 1330 may also include various combinations of different types and forms of transducers that work together or independently to enhance a user's artificial-reality experience. In one example, each of band elements 1332 of haptic device 1330 may include a vibrotactor (e.g., a vibrotactile actuator) configured to vibrate in unison or independently to provide one or more of various types of haptic sensations to a user.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive data to be transformed, transform the data, output a result of the transformation to form a first layer, use the result of the transformation to form second and third layers, and store the result of the transformation to manufacture a multi-layered electronic device. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
a first layer that includes a plurality of digital pixel sensors configured to detect light;
a second layer that includes one or more image processing components configured to process the light detected by the digital pixel sensors; and
a third layer that includes one or more machine learning (ML) hardware processing components, wherein the image processing components of the second layer are communicatively connected to the ML hardware processing components of the third layer via one or more micro through-silicon vias (uTSVs).

2. The system of claim 1, wherein the image processing components of the second layer comprise at least one of an analog-to-digital converter (ADC), an encoder, a memory, or a transmitter.

3. The system of claim 1, wherein the ML hardware processing components control capture of consecutive image frames.

4. The system of claim 1, wherein the ML hardware processing components are configured to execute one or more smart applications.

5. The system of claim 4, wherein at least one of the one or more smart applications comprises a smart image processing application.

6. The system of claim 1, wherein the ML hardware processing components include a plurality of processing cores.

7. The system of claim 6, wherein one or more of the processing cores are configured to perform local processing on a specified portion of an image captured by the plurality of digital pixel sensors.

8. The system of claim 7, wherein the ML processing cores share information to perform centralized processing that stitches the image captured by the plurality of digital pixel sensors together.

9. The system of claim 6, wherein one or more of the processing cores is configured to recognize one or more objects within a specified region of an image.

10. The system of claim 9, wherein one or more of the processing cores is configured to track the one or more recognized objects across a plurality of subsequent images.

11. The system of claim 10, wherein the one or more recognized objects are tracked across the plurality of subsequent images without neighboring pixel data from other ML processing cores.

12. The system of claim 10, wherein the one or more recognized objects are processed by the same ML processing core until the objects are no longer present in the image.

13. The system of claim 10, wherein the one or more recognized objects are processed by a plurality of ML processing cores upon determining that the objects have moved between images.

14. An electronic device comprising:
a first layer that includes a plurality of digital pixel sensors configured to detect light;
a second layer that includes one or more image processing components configured to process the light detected by the digital pixel sensors; and
a third layer that includes one or more machine learning (ML) hardware processing components, wherein the image processing components of the second layer are communicatively connected to the ML hardware processing components of the third layer via one or more uTSVs.

15. The electronic device of claim 14, wherein the image processing components of the second layer are configured to combine a plurality of image bits into a combined group of image data bits.

16. The electronic device of claim 15, wherein the combined group of image data bits is transferred as a group to the ML hardware processing components of the third layer through the uTSVs.

17. The electronic device of claim 15, wherein the combined group of image data bits is transferred as a group to the ML hardware processing components using time-based multiplexing.

18. The electronic device of claim 14, wherein at least one of the ML hardware processing components comprises a local memory buffer.

19. The electronic device of claim 18, wherein image data stored in the local memory buffer is processed using a systolic array whose parameters are prestored in the local memory buffer.

20. A method of manufacture comprising:
forming a first layer that includes a plurality of digital pixel sensors configured to detect light;
forming a second layer adhered to the first layer that includes one or more image processing components configured to process the light detected by the digital pixel sensors; and
forming a third layer adhered to the second layer that includes one or more machine learning (ML) hardware processing components, wherein the image processing components of the second layer are communicatively connected to the ML hardware processing components of the third layer via one or more uTSVs.
